(19) United States
(12) Patent Application Publication
(10) Pub. No.: US 2010/0312828 A1
(43) Pub. Date: Dec. 9, 2010

(54) SERVER-CONTROLLED DOWNLOAD OF STREAMING MEDIA FILES

(75) Inventors: Asher Besserglick, Yehud (IL); Yosef Ben Tsur, Tsur-Yigal (IL); Ilan Daniel, Ramat Gan (IL)

Correspondence Address: D. Kligler I.P. Services LTD, P.O. Box 25, Zippori, 17910, IL

(73) Assignee: MOBIXELL NETWORKS LTD., Ra'anana (IL)

(21) Appl. No.: 12/791,013

(22) Filed: Jun. 1, 2010

Related U.S. Application Data
(60) Provisional application No. 61/183,576, filed on Jun. 3, 2009.

(51) Int. Cl. G06F 15/173; G06F 15/16

(52) U.S. Cl. 709/203; 709/231; 709/224; 709/219

(57) ABSTRACT

A method for data communications includes conveying from a server to a client a virtual index file, which identifies multiple sequences of media files available for download to the client, including a plurality of the sequences that contain a given item of streaming content for download to the client at a different, respective data rate for each sequence. A selection is received from the client of a sequence among the plurality of the sequences of the media files. Responsively to the selection, the media files in the sequence are created at the respective data rate and are downloaded to the client.

### CROSS-REFERENCE TO RELATED APPLICATION

This application claims the benefit of U.S. Provisional Patent Application 61/183,576, filed Jun. 3, 2009, which is incorporated herein by reference.

### FIELD OF THE INVENTION

The present invention relates generally to data communications, and specifically to methods and systems for transmitting digital media over a network.

### BACKGROUND OF THE INVENTION

Various methods have been developed for streaming multimedia content, such as audio and video, over packet communication networks. “Streaming” in this context means that the client plays the content (i.e., displays the corresponding images and/or generates sound) simultaneously with receiving the media data over the network, although there may be a small lag due to buffering at the client side. The streamed content may be either live or pre-recorded.

If multimedia content is encoded at a bit rate that exceeds the available transmission bandwidth to a given client, the content received by the client will be degraded or possibly unusable. Various solutions have therefore been proposed to enable the data transmission rate to be adjusted to fit the resources, such as bandwidth and processing capabilities, of each client. For example, U.S. Pat. No. 7,444,418, whose disclosure is incorporated herein by reference, describes a method in which the available transmission rate of a downlink channel is estimated by calculating packet round trip times and congestion windows. If the transmission rate at which the multimedia information is encoded is greater than the available transmission rate, the multimedia information is transcoded to conform to the available transmission rate.

Various network protocols are used in delivering streaming media, including both real-time protocols and query/response protocols, such as the Hypertext Transfer Protocol (HTTP). In schemes of the latter type, an item of media content may be downloaded in a sequence of media files as the client plays the item. For example, Apple Inc. (Cupertino, Calif.) has developed an architecture known as HTTP Live Streaming for delivery of audio and video over HTTP using ordinary Web servers. HTTP Live Streaming supports multiple alternate streams at different bit rates, and the client software can switch streams as network bandwidth changes. Further details of this architecture are described in a white paper entitled, “HTTP Live Streaming Overview” (2010), which is available on the Apple Web site at developer.apple.com/iphone/library/documentation/Networki ngInternet/Conceptual/StreamingMediaGuide/StreamingMediaG uide.pdf, and in an Internet Draft by Pantos, entitled “HTTP Live Streaming” (draft-pantos-http-live-streaming-03, Apr. 2, 2010), available at tools.ietf.org/html/draft-pantos-http-live-streaming-03. These documents are incorporated herein by reference. The citation of these documents should not be construed as an admission that any of the information they contain constitutes prior art against the present patent application.

### SUMMARY OF THE INVENTION

Embodiments of the present invention that are described hereinbelow provide methods for media streaming with enhanced server-side control.

There is therefore provided, in accordance with an embodiment of the present invention, a method for data communications, including conveying from a server to a client a virtual index file, which identifies multiple sequences of media files available for download to the client, including a plurality of the sequences that contain a given item of streaming content for download to the client at a different, respective data rate for each sequence. Responsively to receiving a selection from the client of a sequence among the plurality of the sequences of the media files, the media files in the sequence are created at the respective data rate and are downloaded to the client.

Typically, the server conveys virtual index files, receives selections, and creates and downloads the media files to and from multiple clients concurrently. In disclosed embodiments, receiving the selection includes receiving a Hypertext Transfer Protocol (HTTP) request from the client, and downloading the media files includes conveying one or more HTTP responses to the client.

In some embodiments, the method includes monitoring, at the server, an available bandwidth for transmission of the media files to the client, and creating the media files includes modifying the data rate responsively to changes in the available bandwidth. Modifying the data rate may include encoding the streaming content at a first data rate in a first part of a given media file and at a second data rate, different from the first data rate, in a second part of the given media file.

In some embodiments, creating the media files includes receiving a media channel at the server from a media source at an input data rate, and transcoding and segmenting the media channel at the server so as to generate the media files with an output data rate different from the input data rate. The media channel may be transcoded and segmented on the fly, in response to the selection from the client.

Alternatively or additionally, creating the media files may include storing the transcoded media channel in a memory of the server and, in response to the selection from the client, reading the transcoded media channel from the memory, and segmenting the transcoded media channel into the media files. In a disclosed embodiment, storing the transcoded media channel includes transcoding and storing the media channel in response to a first request from a first client, wherein the transcoded media channel is read from the memory and segmented multiple times in response to subsequent requests from other clients. Additionally or alternatively, storing the transcoded media channel includes transcoding and storing multiple media files for the media channel with different, respective stored-file data rates, and reading the transcoded media channel includes selecting the media files from the memory with different stored-file data rates in alternation so that the output data rate is, on average, not equal to any of the stored-file data rates.

There is also provided, in accordance with an embodiment of the present invention, apparatus for data communications, including a client interface, which is configured to communicate with a client over a communication network. A processor is configured to convey via the client interface to the client a virtual index file, which identifies multiple sequences of media files available for download to the client, including a plurality of the sequences that contain a given item of streaming content for download to the client at a different, respective data rate for each sequence, to receive a selection from the client of a sequence among the plurality of the sequences of the media files, and responsively to the selection, to create the media files in the sequence at the respective data rate and to download the media files to the client.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a communication system, in accordance with an embodiment of the present invention;

FIG. 2 is a block diagram showing details of a media server, in accordance with an embodiment of the present invention; and

FIGS. 3A and 3B are block diagrams showing details of a media server, in accordance with another embodiment of the present invention.

### DETAILED DESCRIPTION OF EMBODIMENTS

Some progressive download systems that are known in the art, such as the above-mentioned Apple HTTP Live Streaming system, permit the client device to choose the data rate at which it is to receive media files. To support this sort of client choice, the server stores multiple versions of each content item, at different data rates, and presents the available choices to the client in an index file.

In embodiments of the present invention, on the other hand, a media server conveys a virtual index file to clients. The virtual index file identifies sequences of media files that are available for download to the client, without the server necessarily having actually created or stored the media files (and hence the name “virtual” index file, since the files listed in the index may not yet exist). Each sequence of media files corresponds to an item of streaming content, such as a live or pre-recorded video program. Typically, for each content item of this sort, there may be multiple sequences listed in the virtual index file, offering the item for download to the client at different, respective data rates.

After receiving the virtual index file, the client requests one of the listed media file sequences from the server. In response to the client's selection, the media server creates the requested media files at the appropriate data rate and sends the media files to the client. As a result of this approach, the server is able to limit its use of processing and storage and optimize the processing and storage that it does use to generate and hold content items actually requested by clients. Although the client may use a standard protocol (such as HTTP Live Streaming) to select the media files it wishes to receive, the server is able to adjust the data rate dynamically, notwithstanding the client's choice. Thus, the server may monitor the available bandwidth, as well as other resources, and may accordingly change the actual rate of data that the client receives. This server-based approach also enables the server to respond quickly to client channel change requests, since the server can curtail the file that it is currently transmitting, rather than having to wait for opening of a new URL before beginning to transmit the new channel or changing the bit rate.

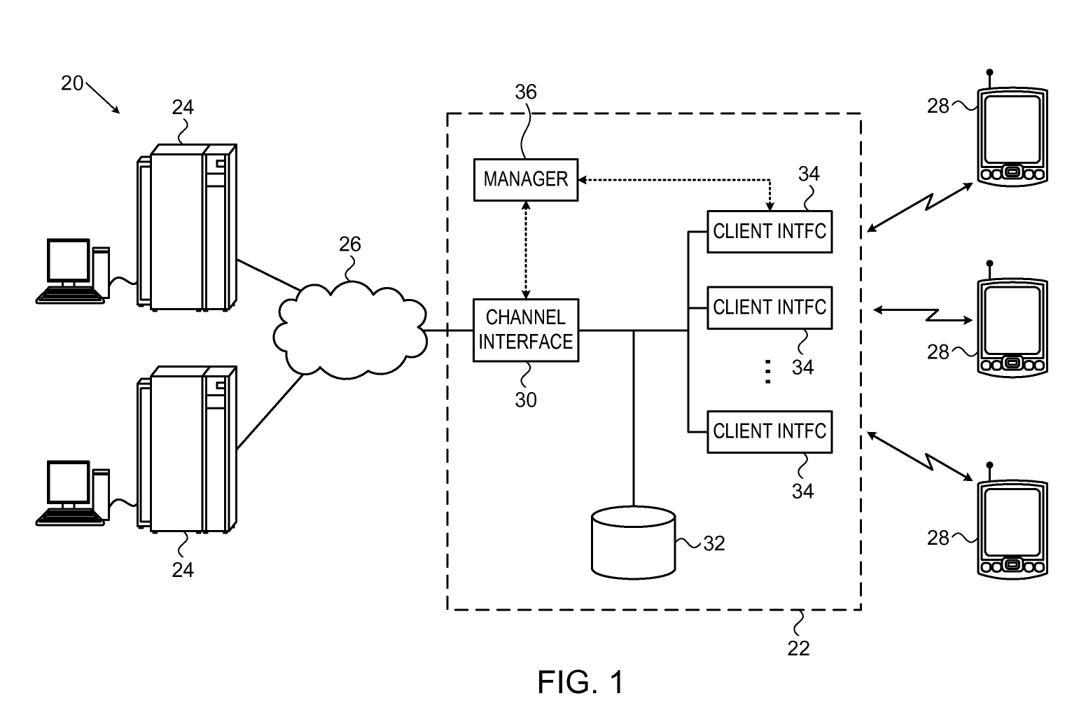

FIG. 1 is a block diagram that schematically illustrates a communication system 20, in accordance with an embodiment of the present invention. A media server 22 receives various items of media content (such as video programs) from one or more content servers 24, typically via a network 26, such as the Internet or an intranet. Server 22 distributes the content to multiple clients 28 concurrently in response to client requests (possibly as a video on demand service). Clients 28 are pictured in FIG. 1 as mobile devices, which communicate with server over wireless links, via a cellular network, for example. Such clients may comprise, for example, cell phones, personal digital assistants, or portable media players, for example. Alternatively or additionally, clients 28 may comprise personal computers or television set-top boxes (not shown), which communicate with server 22 over either wireless or wired links.

Server 22 typically comprises a general-purpose computer or a cluster of such computers, with suitable interfaces and software for carrying out the functions that are described herein. The software may be downloaded to the computer in electronic form, over a network, for example. Alternatively or additionally, the software may be held on tangible, non-transitory storage media, such as optical, magnetic, or electronic memory media. Further alternatively or additionally, at least some of the functions of server 22 may be performed by dedicated or programmable hardware logic circuits.

Server 22 is connected to network 26 via a high-speed data interface, referred to herein as a channel interface 30, through which the server receives multiple channels of media content, which may be live or pre-recorded, from content servers 24. Although only a single channel interface is shown in the figures, server may comprise multiple channel interfaces, such as a respective channel interface for each content channel that the server receives. The server may store at least some of the media content that it receives in a memory 32, as described further hereinbelow. Multiple client interfaces 34 interact with respective clients 28, typically (although not necessarily) with an individual client interface for each client. Typically, the client interfaces are configured as HTTP servers (or share one or more HTTP servers), which receive requests and return responses to the clients. Alternatively, the client interfaces may implement other file-based protocols, as are known in the art, either standard or proprietary. Client interfaces 34 communicate with clients 28 via appropriate network connections and modems, which are known in the art and are omitted from the figures for the sake of simplicity.

A management processor 36 oversees and coordinates the operation of channel interface 30 and client interfaces 34. These management functions, like those of the channel and client interfaces, are described in detail with reference to the figures that follow. Processor 36 typically comprises a central processing unit (CPU), running suitable software to perform the required functions. At least some of the functions of the channel interface and client interfaces may similarly be implemented as software processes, running on the same CPU as management processor 36 or on other CPUs.

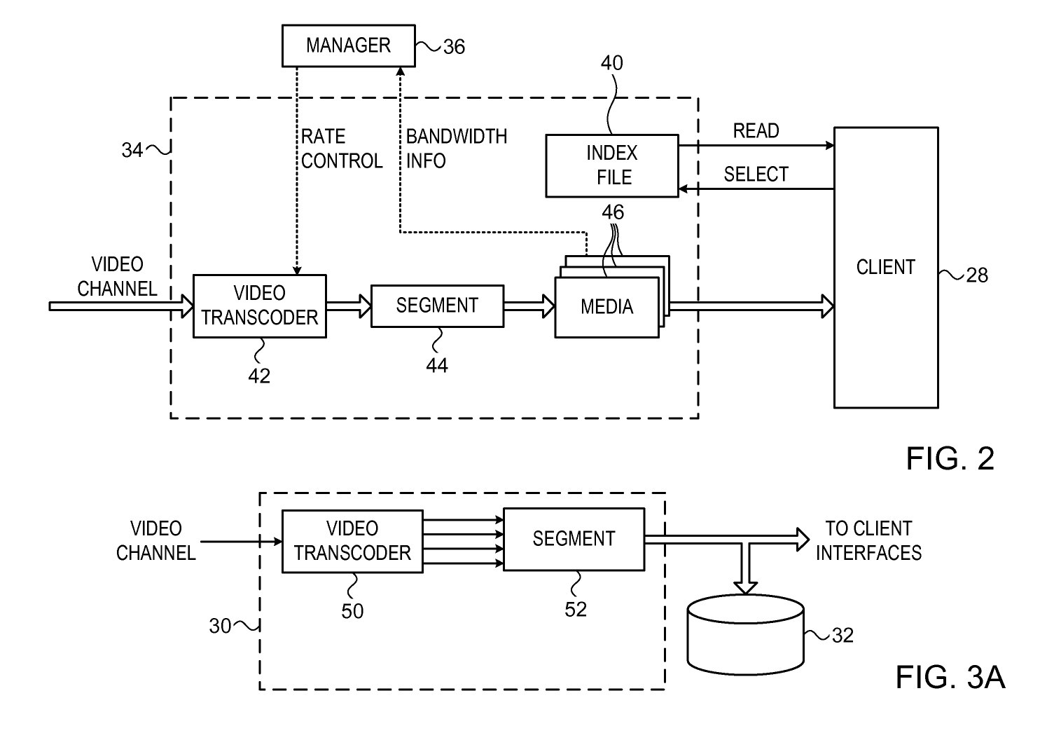

FIG. 2 is a block diagram showing details of one of client interfaces 34, in accordance with an embodiment of the present invention. The figure shows the functionality of a single client interface, serving one client 28. This functionality is replicated for each client in communication with server 22. The blocks within client interface 34 in FIG. 2 are functional blocks, which do not necessary correspond to discrete physical components.

Management processor 36 generates a virtual index file 40, listing available media content files, typically including multiple versions of at least some of the items of content at different, respective data rates. (The files are “available” not in the sense that they already necessarily exist, but rather in the sense that they can be created, if necessary, and supplied when requested by the client.) The virtual index file may have the same format as a conventional index file provided by known standards, such as the above-mentioned HTTP Live Streaming, and indicates locations for request of the content items. For HTTP communications, the locations listed in the index file may have the form of universal resource locators (URLs). As noted earlier, however, the content files listed in virtual index file 40 may not exist a priori, but may rather be generated by client interface 34 on demand, i.e., at least some of the content files are themselves “virtual” at this stage.

Client interface 34 downloads virtual index file 40 to client 28, typically in response to a HTTP request from the client, and then receives the client's program selection as a further HTTP request. If the index file offers multiple data rates of the client's selected program, then the client's selection indicates the preferred data rate, typically based on the client's own assessment of the available bandwidth between server 22 and the client.

Based on the client's selection, management processor 36 instructs a video transcoder 42 to select the desired program channel, coming in via channel interface 30, and to transcode the corresponding media content to the selected data rate. The term “transcoding,” as used in the context of the present patent application and in the claims, includes adjusting the data rate (also known as “transrating”), as well as modifying the encoding format as necessary for compatibility with client 28. For video applications, transcoder 42 may, for example, output a MPEG-2 transport stream or MP4 files, or any other suitable format that is known in the art, wherein the average number of bits per second is determined by the selected data rate. In some cases, when the bandwidth between server 22 and client 28 is sufficient and the incoming media stream is in the proper format already, transcoder 42 may simply pass the stream through without change.

A segmenter 44 divides the media stream output by transcoder 42 to create a sequence of media files 46. Client 28 requests the media files one-by-one, typically using HTTP requests directed to the appropriate URLs. As noted above, transcoder 42 and segmenter 44 typically create media files 46 on the fly, as the client requests them. Client 28 begins by downloading the first file 46 in the selected sequence, and then plays each file in the sequence while at the same time requesting and receiving subsequent files.

Management processor 36 monitors the bandwidth on the downlink to client 28 in order to detect any possible mismatch between the available bandwidth and the data transmission rate. For example, when media files 46 are transmitted to client 28 using HTTP over the Transport Control Protocol (TCP), processor 36 may track the TCP acknowledgments and changes in buffer size as an indication of the link bandwidth, as is known in the art. When processor 36 detects that a drop in bandwidth has occurred, it may instruct transcoder 42 to decrease the data rate (even in the midst of generating a media file). Alternatively, the processor may instruct the transcoder to increase the data rate if unexploited bandwidth is available. Further additionally or alternatively, manager 36 may instruct transcoder 42 to change the data rate for other reasons, with decision logic based on factors such as resource provisioning. These rate adjustments may be made in a manner transparent to the client, notwithstanding the data rate that the client selected initially from virtual index file 40.

As a further option, client 28 may choose to change channels in the middle of a program and select a new video channel for viewing. In this case, manager 36 may instruct transcoder 42 and segmenter 44 to stop receiving the current content item (even in the midst of a media file) and change immediately to a different item. Furthermore, when the client chooses a new channel, transcoder 42 may initially output video at a data rate (in bits per second) lower than the data rate selected by the client in order to fill the client's buffer quickly. These measures reduce the play lag that is otherwise incurred when the client selects a new channel to receive.

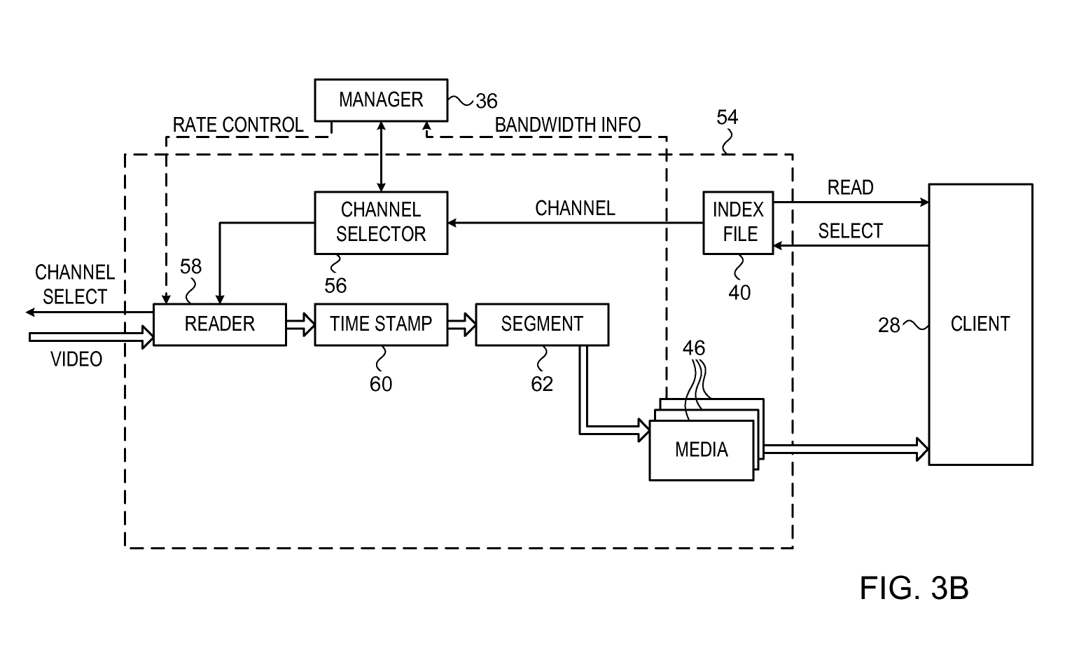

FIGS. 3A and 3B show details of channel interface 30 and a client interface 54, in accordance with another embodiment of the present invention. Client interface 54 may be used in server 22 in place of client interface 34 that is shown in FIGS. 1 and 2. Once again, the blocks in these figures represent functional elements, which do not necessarily correspond to distinct physical components of server 22.

In the present embodiment, a video transcoder 50 receives a channel of video content at a certain input data rate from one of content sources 24, and generates multiple transcoded video streams at different, respective output data rates. Typically, multiple video transcoders of this sort may operate in parallel on different, respective channels. A segmenter 52 arranges the video streams in respective media files, with one file or a sequence of files for each different data rate. Typically, the segmenter aligns the video streams so that each file starts with a key frame (known as “I-frames” in MPEG parlance), and may also index the locations of other key frames in the file.

Segmenter 52 stores the media files in memory 32, which typically comprises a disk array with a suitable file system. Additionally or alternatively, segmenter 52 may pass the media files directly to client interface 54 for real-time transmission. This latter mode of operation is desirable for live transmission. In some cases, particularly for channels that are known to be popular, transcoder 50 and segmenter 52 may transcode and store a certain content item independently of any client request for the item. In other cases, the transcoder and segmenter may transcode a given item only in response to an initial request from a client. As the initial request is served, the transcoded media stream may be both passed to client interface 54 and stored in memory 32. The transcoded data may subsequently be read from the memory multiple times, in response to subsequent requests from other clients. Memory 32 thus serves as a sort of cache.

Management processor 36 receives file descriptors and metadata (such as locations of key frames) from segmenter 52 and uses this information in generating virtual index file 40. Typically, as noted above, the virtual index file lists content items from multiple channels and at multiple different data rates. Client 28 selects one of the files listed in the virtual index file, whereupon a channel selector 56 indicates to a reader 58 which media file should now be read from memory (or brought in by channel interface 30 in case the desired content is not currently in memory 32).

Reader 58 retrieves the appropriate media file or stream to satisfy the client request. For MPEG data, a time stamper 60 inserts new time stamps in the data stream for proper synchronization, and a segmenter 62 divides the stream to create media files 46, suitable for HTTP download to client 28. These media files are typically smaller than the source video files that are stored in memory 32. The functions of segmenter 62 are similar to those of segmenter 44 (FIG. 2), as described above. In addition, segmenter 62 makes changes as necessary in the transport stream (and possibly in the elementary stream of the video) to enable the client to play the successive files as a single, continuous output. Specifically, because the segments that segmenter 62 generates are not necessarily the same size as the segments that were generated by segmenter 52, segmenter may have to change some headers in the transport stream and/or the elementary stream.

Management processor 36 monitors the bandwidth on the downlink to client 28, in a manner similar to the monitoring and rate control functions of management processor 36 that were described above with reference to FIG. 2. When the management processor detects a bandwidth/data rate mismatch, it may instruct reader 58 to select a different file from memory 32 or from encoder 50, with a higher or lower data rate than the current file as appropriate. Reader 58 may select files from memory 32 with different data rates in alternation, and thus may generate an output to client 28 at an average data rate that is not necessary equal to any of the specific stored-file data rates of the files generated by and stored previously by transcoder 50.

Although the figures show certain functional architectures of server 22, the principles of the present invention, and particularly the use of a virtual index file as described above, may be applied, mutatis mutandis, in other architectural schemes. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for data communications, comprising:
conveying from a server to a client a virtual index file, which identifies multiple sequences of media files available for download to the client, including a plurality of the sequences that contain a given item of streaming content for download to the client at a different, respective data rate for each sequence;
receiving a selection from the client of a sequence among the plurality of the sequences of the media files; and
responsively to the selection, creating the media files in the sequence at the respective data rate and downloading the media files to the client.

2. The method according to claim 1, wherein the server conveys virtual index files, receives selections, and creates and downloads the media files to and from multiple clients concurrently.

3. The method according to claim 1, wherein receiving the selection comprises receiving a Hypertext Transfer Protocol (HTTP) request from the client, and wherein downloading the media files comprises conveying one or more HTTP responses to the client.

4. The method according to claim 1, and comprising monitoring, at the server, an available bandwidth for transmission of the media files to the client, and wherein creating the media files comprises modifying the data rate responsively to changes in the available bandwidth.

5. The method according to claim 4, wherein modifying the data rate comprises encoding the streaming content at a first data rate in a first part of a given media file and at a second data rate, different from the first data rate, in a second part of the given media file.

6. The method according to claim 1, wherein creating the media files comprises receiving a media channel at the server from a media source at an input data rate, and transcoding and segmenting the media channel at the server so as to generate the media files with an output data rate different from the input data rate.

7. The method according to claim 6, wherein the media channel is transcoded and segmented on the fly, in response to the selection from the client.

8. The method according to claim 6, wherein creating the media files comprises storing the transcoded media channel in a memory of the server and, in response to the selection from the client, reading the transcoded media channel from the memory, and segmenting the transcoded media channel into the media files.

9. The method according to claim 8, wherein storing the transcoded media channel comprises transcoding and storing the media channel in response to a first request from a first client, and wherein the transcoded media channel is read from the memory and segmented multiple times in response to subsequent requests from other clients.

10. The method according to claim 8, wherein storing the transcoded media channel comprises transcoding and storing multiple media files for the media channel with different, respective stored-file data rates, and wherein reading the transcoded media channel comprises selecting the media files from the memory with different stored-file data rates in alternation so that the output data rate is, on average, not equal to any of the stored-file data rates.

11. Apparatus for data communications, comprising:
a client interface, which is configured to communicate with a client over a communication network; and
a processor, which is configured to convey via the client interface to the client a virtual index file, which identifies multiple sequences of media files available for download to the client, including a plurality of the sequences that contain a given item of streaming content for download to the client at a different, respective data rate for each sequence, to receive a selection from the client of a sequence among the plurality of the sequences of the media files, and responsively to the selection, to create the media files in the sequence at the respective data rate and to download the media files to the client.

12. The apparatus according to claim 11, wherein the processor is configured to convey virtual index files, to receive selections, and to create and download the media files to and from multiple clients concurrently.

13. The apparatus according to claim 11, wherein the selection received from the client comprises a Hypertext Transfer Protocol (HTTP) request, and wherein the processor is configured to download the media files in one or more HTTP responses to the client.

14. The apparatus according to claim 11, wherein the processor is configured to monitor an available bandwidth for transmission of the media files to the client, and to modify the data rate of the content downloaded to the client responsively to changes in the available bandwidth.

15. The apparatus according to claim 14, wherein the processor is configured to encode the streaming content at a first data rate in a first part of a given media file and to modify the data rate so as to encode the streaming content at a second data rate, different from the first data rate, in a second part of the given media file.

16. The apparatus according to claim 11, wherein the processor is configured to receive a media channel from a media source at an input data rate, and to transcode and segment the media channel so as to generate the media files with an output data rate different from the input data rate.

17. The apparatus according to claim 16, wherein the processor is configured to transcode and segment the media channel on the fly, in response to the selection from the client.

18. The apparatus according to claim 16, and comprising a memory, which is configured to store the transcoded media channel, wherein the processor is configured to read the transcoded media channel from the memory and to segment the transcoded media channel into the media files in response to the selection from the client.

19. The apparatus according to claim 18, wherein the processor is configured to transcode and store the media channel in response to a first request from a first client, to read from the memory and segment the transcoded media channel multiple times in response to subsequent requests from other clients.

20. The apparatus according to claim 18, wherein the memory is configured to store multiple media files for the media channel with different, respective stored-file data rates, and wherein the processor is configured to select the media files from the memory with different stored-file data rates in alternation so that the output data rate is, on average, not equal to any of the stored-file data rates.
